(19) United States
(12) Patent Application Publication
(10) Pub. No.: US 2012/0030131 A1
(43) Pub. Date: Feb. 2, 2012

(54) SYSTEM AND METHOD FOR OPTIMIZING THE EFFECTIVENESS OF AN EDUCATIONAL INSTITUTION

(75) Inventors: Peter Gibbons, Fairfax, VA (US); James Etter, Fairfax, VA (US)

(73) Assignee: American Public University Systems, Inc., Charles Town, WV (US)

(21) Appl. No.: 13/013,922

(22) Filed: Jan. 26, 2011

Related U.S. Application Data
(63) Continuation-in-part of application No. 11/032,587, filed on Jan. 10, 2005, now Pat. No. 7,882,041.
(60) Provisional application No. 60/535,566, filed on Jan. 9, 2004.

(51) Int. Cl. G06Q 50/20

(52) U.S. Cl. 705/327

(57) ABSTRACT

A system and method for optimizing the effectiveness of an educational institution. A rules engine receives a request to manage an academic plan of a student from a user access device. The rules engine accesses a datastore and selects data based on the request that are indicative of the standing of the student with the educational institution at a point in time. The rules engine also selecting rules stored in a datastore based on the request. The rules engine applies the selected rules to the selected data to determine whether to grant the request. The data stored in the first memory are updated when the request is granted.

### RELATIONSHIP TO OTHER APPLICATIONS

This application is a continuation-in-part application of U.S. patent application Ser. No. 11/032,587 filed Jan. 10, 2005, which application claims the benefit of U.S. Provisional Application No. 60/535,566 filed Jan. 9, 2004. The 11/032,587 and the 60/535,566 application are hereby incorporated by reference in their entireties for all purposes.

### BACKGROUND

The phrase “educational institution” typically engenders images of a physical place, perhaps with a tree-lined campus, student dormitories, and a faculty member lecturing before a classroom of students. The Internet has spawned another kind of educational institution, one with a virtual classroom in which students interact with a teacher via a computer. While brick and mortar facilities have not been replaced, the Internet has brought the content of the classroom to the home and office.

All educational institutions strive to meet each student's particular needs, to provide the resources needed to meet the institutions commitment to the students, and to measure the effectiveness of the institution in accomplishing its goals. The measures used by brick and mortar facilities and current distance learning institutions are the same. Attendance, homework, test scores, and exams and similar measures are used to evaluate students. The resources of an educational institution are allocated based on the intended course of study indicated by students in their applications and at registration. Such institutions measure their own performance based on drop-out and graduation ratios.

These measures suffer because they are determined after the fact. By the time it is known that a student has lost interest in classwork, it may be too late to counsel him or her. Allocating resources solely based on applications or registrations places the institution at risk of misallocating those resources should students change their academic plans. Drop-out ratios and graduation ratios do not permit an institution to detect and correct problems on a timely basis.

The Internet has also changed the way the physical educational institution interacts with students. For example, course registration servers are used by colleges and universities to interact with students. Typically, an enrolling student visits a Web site where that student enters his or her name, selects courses from descriptions displayed on the site, and is advised as to the availability of the course session and the times that it is provided. Network-based course registration provides a student a means to manage class requirements and schedules. From the perspective of the educational institution, network-based course registration is a management tool that automates the registration process and allows limited means for institutions to track course participation by category, subcategory, location, and/or course number.

In a network-based distance-learning environment (herein, a “virtual university”), a student is not only expected to register for classes electronically, but to receive course material, take tests, and obtain guidance via an electronic classroom formed by networking students and an instructor. However, unless the student is asking for assistance or an observant teacher notes problems in the student's class work, the electronic classroom setting alone does little to measure a student's performance during the student's involvement with the virtual university. Further, the electronic classroom provides little in the way of guidance as to the prospective resources needed by the virtual university to satisfy its commitments to its students.

### SUMMARY

Embodiments herein are directed to systems and methods for interacting with a user device to establish a relationship between a user of the user device and on-line education institution and for measuring the success of those interactions.

In an embodiment, a student's progress and needs are monitored from registration through and beyond graduation. In this embodiment, a student and an educational institution interact via a network interface. This interaction evolves through various monitoring stages. By way of illustration and not as a limitation, the relationship starts with the initial contact stage, and moves through an acceptance stage, a first course stage, a last course stage, a graduation stage, and finally an alumni stage. Each of these stages has a family of measures (FOM) comprising one or more performance metrics that are used in conjunction with rules to gauge the progress and/or experience of the student in progressing to and through that stage and to determine whether a student needs assistance.

In another embodiment, each student establishes a dynamic academic plan that is monitored by automated systems to dynamically manage university resource requirements prospectively. In an embodiment, “automated filters,” which are essentially rules administered by a rules engine, are applied to a student record to guide a student to the correct courses based on his or her current academic progress in a declared major. In this embodiment, a student interacts with a graphical user interface that reflects the outcome of rules administered by the rules engine. The rules may, for example, ensure that the student cannot inadvertently register in a course for which the program requirements are already fulfilled by a previous course or transfer credit, and cannot register in a course without meeting all entry requirements for that course. Other rules prevent errors of various types being made or provide advice to students on courses and other administrative matters.

### DESCRIPTION OF THE DRAWINGS

FIG. 1 illustrates a block diagram of a virtual university according to an embodiment.

FIG. 2 illustrates a sequence of monitoring stages according to various embodiments.

FIG. 3 illustrates the components of an FOM according to an embodiment.

FIG. 4 illustrates a flow diagram of an initial contact stage according to an embodiment.

FIG. 5 illustrates a flow diagram of an acceptance stage according to an embodiment.

FIG. 6 illustrates a flow diagram of a first course stage according to an embodiment.

FIG. 7 illustrates a flow diagram of last course stage according to an embodiment.

FIG. 8 is a block diagram illustrating a graphical user interface presented on a user access device and connected to a rules engine for dynamically creating and revising an academic plan according to an embodiment.

FIG. 9 is a block diagram illustrating functional components of a personal computer.

FIG. 10 is a block diagram illustrating functional components of a server.

### DETAILED DESCRIPTION

As indicated above, the 11/032,587 and the 60/535,566 applications are incorporated by reference in their entireties for all purposes. Without limiting the foregoing, subject matter from various drawings, and discussions of those drawings, is incorporated herein and may be referenced in the claims.

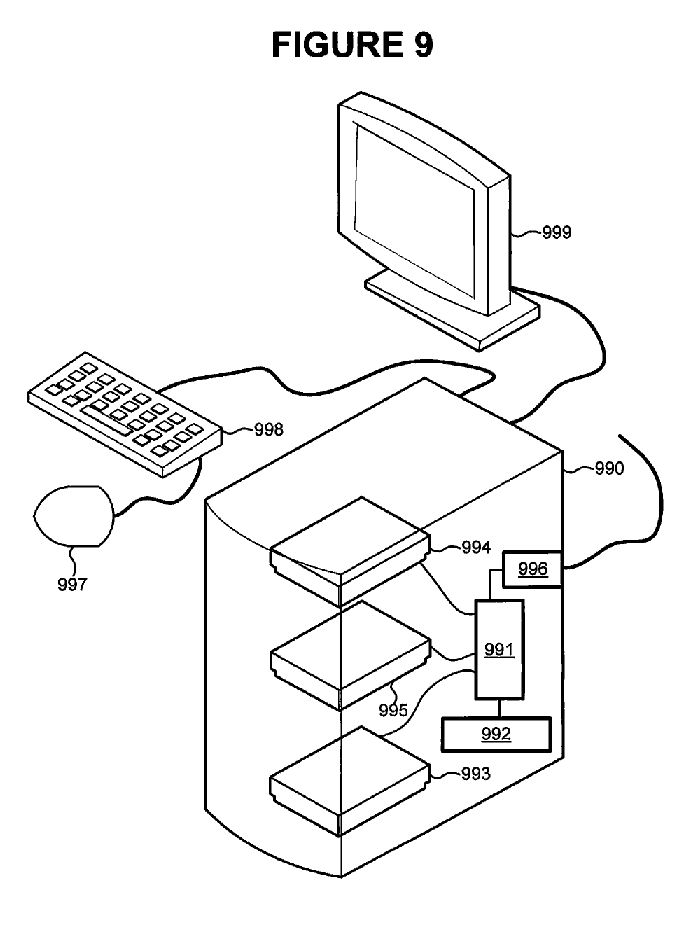

In the descriptions that follow, the various determinations, computations and operations may be performed using a processor executing software instructions. For example, the processor of a personal computer may be used for this purpose. By way of illustration, the functional components of a personal computer 990 are illustrated in FIG. 9. Such a personal computer 990 typically includes a processor 991 coupled to volatile memory 992 and a large capacity nonvolatile memory, such as a disk drive 993. The computer 990 may also include a floppy disc drive 994 and a compact disc (CD) drive 995 coupled to the processor 991. Typically the computer device 990 will also include a pointing device such as a mouse 997, a user input device such as a keyboard 998 and a display 999. The computer device 990 may also include a number of connector ports coupled to the processor 991 for establishing data connections or receiving external memory devices, such as USB or FireWire® connector sockets or other network connection circuits 996 for coupling the processor 991 to a network. In a notebook configuration, the computer housing includes the pointing device 997, keyboard 998 and the display 999 as is well known in the computer arts.

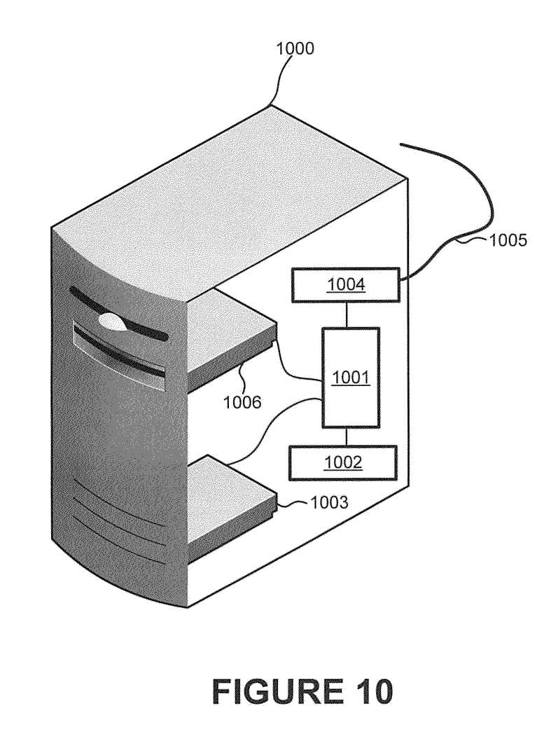

A number of the aspects described above may also be implemented with any of a variety of remote server devices, such as the server 1000 illustrated in FIG. 10. Such a server 1000 typically includes a processor 1001 coupled to volatile memory 1002 and a large capacity nonvolatile memory, such as a disk drive 1003. The server 1000 may also include a floppy disk drive and/or a compact disc (CD) drive 1006 coupled to the processor 1001. The server 1000 may also include a number of connector ports 1004 coupled to the processor 1001 for establishing data connections with network circuits 1005. When used herein, the term “server” refers to a hardware device unless otherwise stated.

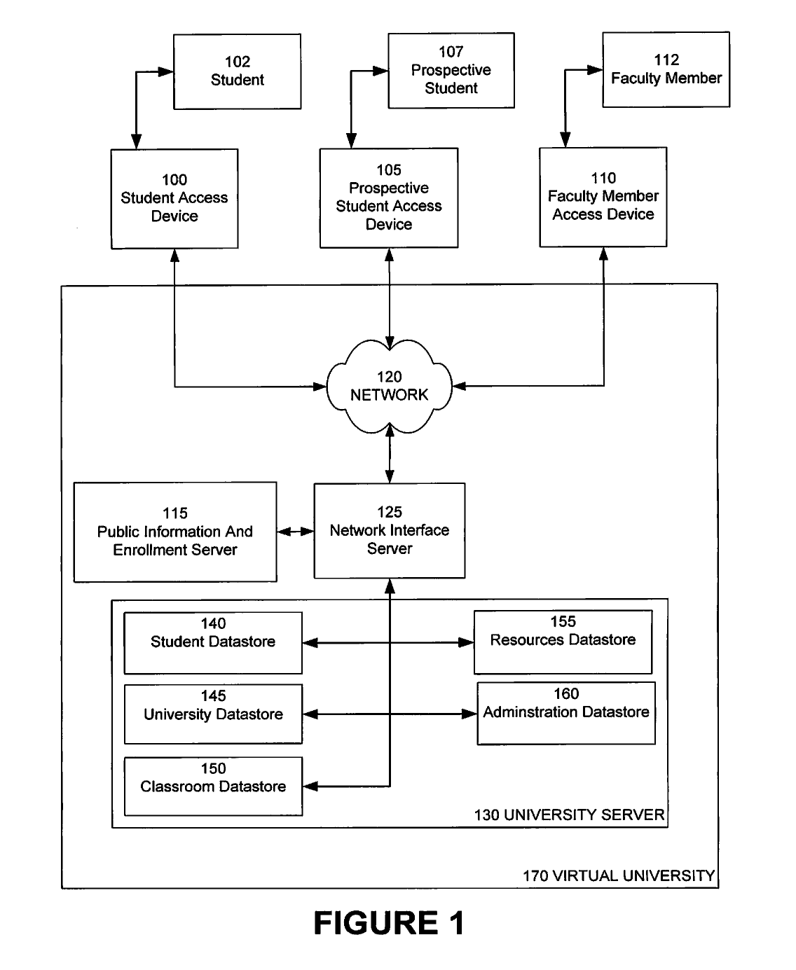

FIG. 1 illustrates a block diagram of a virtual university according to an embodiment. A student access device 100 operated by a student 102, a prospective student access device 105 operated by a prospective student 107, and a faculty member 110 access device operated by a faculty member 112 (collectively, “remote users”) each have access to a network interface 125 server via a network 120. The network interface server 125 determines whether a particular remote user may “enter” (access) a virtual university 170 operating on university server 130. By way of illustration, a student 102 presenting the proper credentials may enter the virtual university 170 and access a student record (not shown) in a student datastore 140 pertaining to that student 102 only. A faculty member 112 presenting the proper credentials may enter the virtual university 170 and access those student records in student datastore 140 that pertain to each student 102 enrolled in one or more classes taught by that faculty member 112. A prospective student 107 may not enter the virtual university 170 but may access a public information and enrollment server 115.

In an embodiment, a virtual university 170 comprises a student datastore 140, a university datastore 145, a classroom datastore 150, a resources datastore 155, and an administration datastore 160.

Student datastore 140 comprises a student record pertaining to each student 102. By way of illustration and not as a limitation, a student record includes classes taken, current class schedule, class performance measures, projected class schedule, personal datastore, and payment datastore.

University datastore 145 comprises information about the virtual university 170. By way of illustration and not as a limitation, such information includes courses offered, current registrations for particular classes, relationships between classes such a pre- and co-requisites, degree requirements, news, and a contact directory.

Classroom datastore 150 comprises information relating to a particular course in which each student 102 is enrolled. By way of illustration and not as a limitation, such information includes course assignments, answers to questions, lecture notes, and data measuring the performance of each student 100 enrolled in the course.

Educational resources datastore 155 comprises links to educational resources both inside and outside the virtual university 170.

Administration datastore 160 comprises information relating to the management of the virtual university 170. In an embodiment, the degree plans of all students are evaluated to determine the administrative resources required by the virtual university 170 to fulfill its commitments to its students.

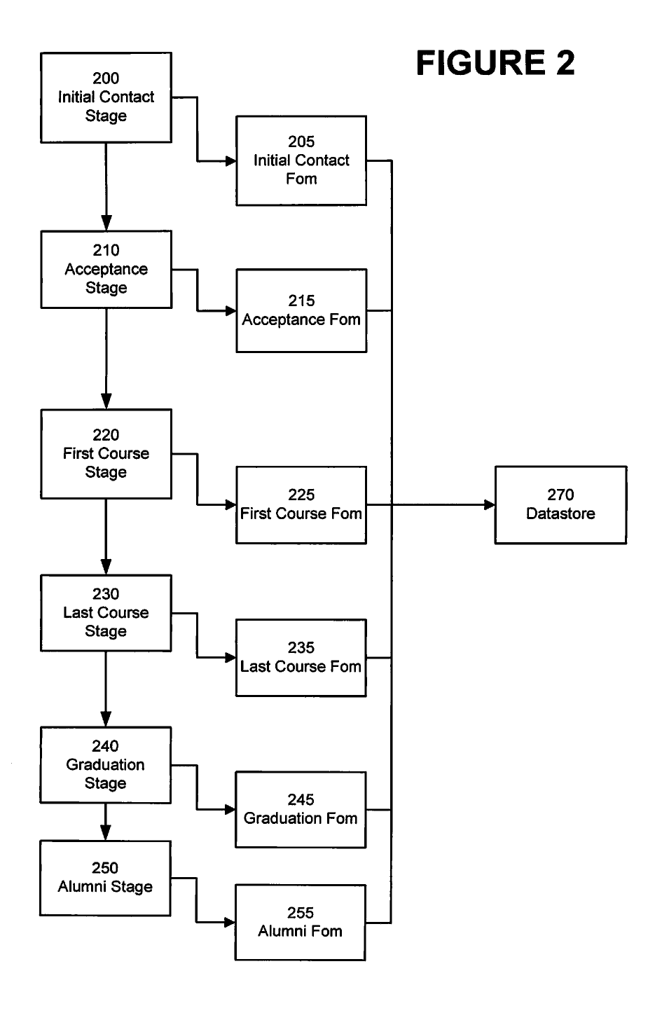

FIG. 2 illustrates a sequence of monitoring stages according to various embodiments. In this embodiment, the relationship between the virtual university and the student starts with the initial contact stage 200, and moves through an acceptance stage 210, a first course stage 220, a last course stage 230, a graduation stage 240, and an alumni stage 250. Each of these stages has a family of measures (FOM) comprising one or more performance metrics that are used to in conjunction with rules to gauge the effectiveness of the virtual university programs at any stage. Initial contact FOM 205, acceptance FOM 215, first course FOM 225, last course FOM 235, graduation FOM 245, and alumni FOM are connected to a central datastore 270. The data generated by each FOM is stored in datastore 270. While FIG. 2 illustrates six discrete monitoring stages, this is not meant as a limitation. Other monitoring stages may be defined or two monitoring stages combined. As previously indicated, the creation and use of the FOMs may be performed by a processor element, such as a processor element in a server (see FIG. 9) and/or a personal computer (see FIG. 10).

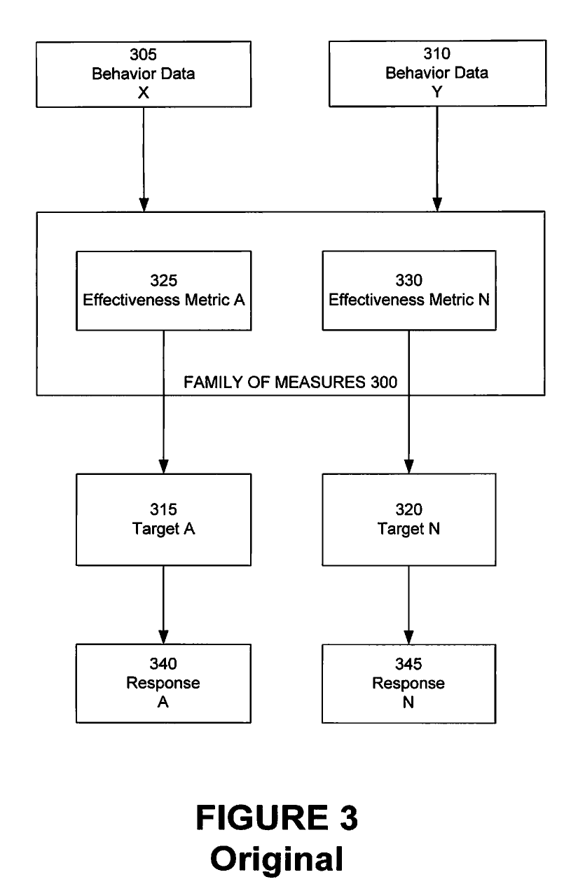

FIG. 3 illustrates the generation and application of an FOM according to an embodiment of the present invention. Referring to FIG. 3, FOM 300 receives behavior data X 305 and behavior data Y 310. From these data, effectiveness metric A 325 and an effectiveness metric N 330 are computed. Associated with effectiveness metric A 325 is a target A 315 and associated with effectiveness metric N 330 is a target N 320. A determination is made whether the effective metric A 325 achieves or exceeds the target A. If not, a response A 340 is initiated. Similarly, a determination is made whether the effective measure N 330 achieves or exceeds the target N. If not, a response N 345 is initiated.

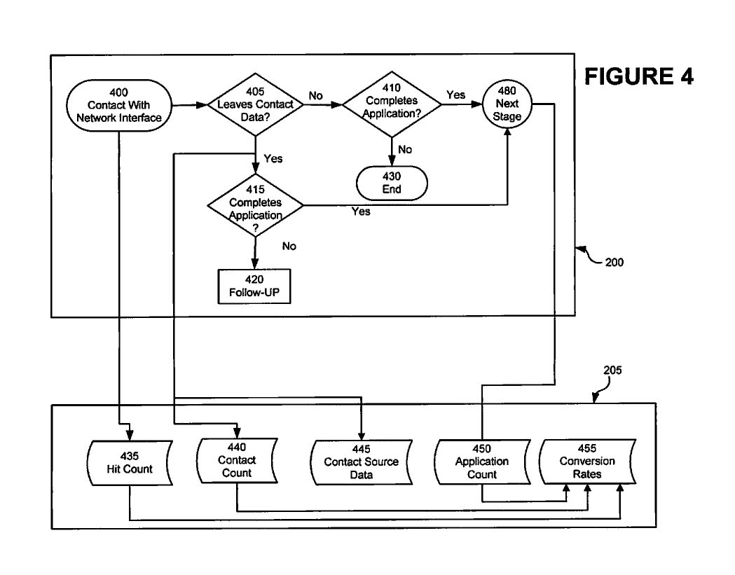

The relationship between a prospective student and a virtual university begins with prospective student's initial contact with the virtual university (sometimes referred to herein as the “initial contact stage”). FIG. 4 illustrates a flow diagram of an initial contact stage according to an embodiment. This contact may be achieved by any means of communication (phone, e-mail, trade show or educational event, etc.). In an embodiment, a prospective student enters an initial contact stage by using a student access device (see FIG. 1, 100) to communicate via the network interface 400 with a public information and enrollment server (see FIG. 1, 115). The prospective student decides whether to leave contact data 405. If the prospective student leaves contact data, the prospective student may further elect to complete an application 415. A prospective student who elects to leave contact data 405 but not complete an application 415 is flagged for a follow-up procedure.420.

Alternatively, a prospective student may forgo leaving contact data but complete an application 410. Finally, a prospective student may elect to terminate communications with the public information and enrollment server (see FIG. 1, 115) without leaving contact data 405 and without completing an application 410, in which case the process ends 430.

In an embodiment, an Enrollment Management Department follows up on prospective students who leave contact information. Enrollment management specialists (EMSs) send e-mails and contact these individuals by phone to provide more information and/or links to various subject and program locations on the website. The follow-up to these prospective students also includes e-mails that are auto-generated. This automated function may be performed by a processor element, such as a processor element in a server (see FIG. 29) and/or a personal computer (see FIG. 30).

An initial contact stage FOM uses information captured during the initial contact stage to measure stage performance. A hit count register 435 captures the number of unique visitors to the information and enrollment server. A contact count register 440 captures the number of prospective students leaving contact information while a contact source data register 445 captures the location or source of the prospective students and how each prospective student found out about the virtual university. An application count register 450 captures the number of students completing applications. The FOM also monitors the conversion rate 455 from visiting the web to leaving contact information to filling out applications 450. With these data the virtual university 170 is able to measure and strengthen its partnership with the prospective student during the initial contact stage.

By way of illustration and not by way of limitation, a conversion rate may include the following:

a hit count to a contact count;

a hit count to an application count, and

a contact count to the application count.

In an embodiment, a datastore (see FIG. 2, 270) receives information from the various registers. As previously indicated, the use of the initial contact stage FOM may be performed by a processor element, such as a processor element in a server (see FIG. 9) and/or a personal computer (see FIG. 10).

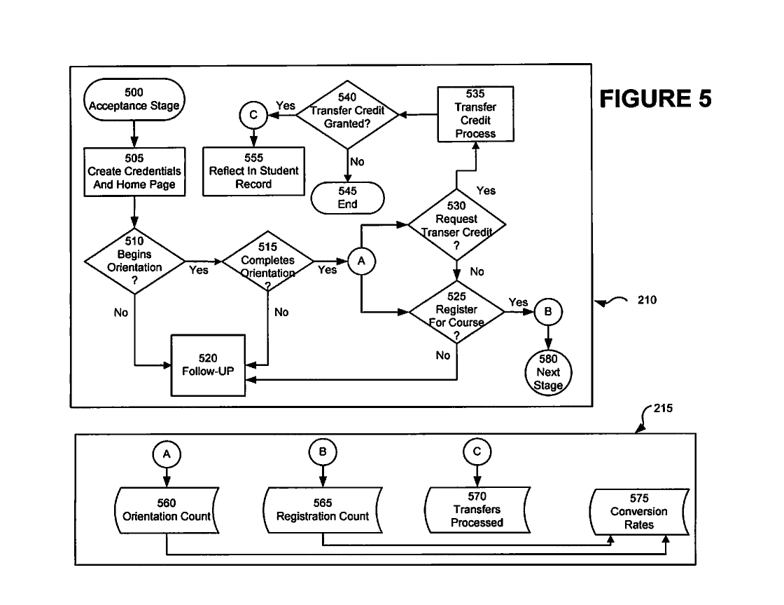

FIG. 5 illustrates a flow diagram of an acceptance stage according to an embodiment. Referring to FIG. 5, a prospective student who has completed an application enters an acceptance stage 500. The prospective student uses a student access device (see FIG. 1, 100) to create credentials 505 that allow the prospective student to enter the virtual university. In an embodiment, the credentials comprise an ID number and password. The prospective student also creates a student home page 505 from which the student may link to one or more datastores (see FIG. 1).

In another embodiment, a prospective student determines whether to begin orientation 510. Student orientation focuses on four areas: academic policies and standards, student rights and responsibilities, financial planning, and academic planning. The student signs off to acknowledge an understanding of the data as s/he completes each of the first three sections. During the fourth section the student declares his/her degree. Although the student is not able to return to the orientation once it is completed, the online student handbook is provided inside each campus as a reference for each topic covered.

The academic policies and standards section introduces the student to important data about admission statuses, documents required for full admission, transfer credit evaluation, course extension and withdrawal, and institutional requirements. The student rights and responsibilities section teaches the student about what is expected regarding attendance and professor contact, how to access online information, and how to use course projection. It also informs the student of privacy rights and the virtual university's 170 writing and plagiarism policies. The financial planning section covers tuition and fees, payment options, scholarships, loans, and the refund policy. Finally, the academic planning section guides the student through the process of declaring his or her intent to pursue a degree or certificate program via an online academic program builder.

To complete orientation, the student must declare an academic goal. In order to do this, the student is led through an academic program builder where s/he declares a degree or non-degree program: associate's, bachelor's, master's, undergraduate or graduate certificate or short professional program. The student may also declare a major and/or concentration. Upon submitting a final choice, the virtual university 170 “builds” an academic program for the student based upon application of rules from a rules engine and presents a comprehensive list of courses required for graduation or completion of the declared program. This automated function may be performed by a processor element, such as a processor element in a server (see FIG. 9) and/or a personal computer (see FIG. 10).

After completing orientation, the student may refer to the student handbook for assistance and guidance on all the system's policies, processes, and procedures. The student handbook is accessible from both inside and outside of the electronic campus and is considered the primary reference for answers to questions about financial aid, tuition assistance, refunds, registration, course drop/withdrawal, course extension, the virtual university's 170 grading policies, making successful academic progress, and student rights and responsibilities.

If the prospective student chooses not to begin orientation, a follow-up procedure 520 is initiated. In an embodiment, a student service representative provides the prospective student more information or assists them with returning to finish the orientation so that they are able to register for their first course.

If the prospective student elects to begin registration, the student determines whether to complete registration 515. If the student does not complete registration, a follow-up procedure is initiated 520. If a student completes registration, the student is offered an opportunity to register for a course 525 and an opportunity to request evaluation of transfer credits 530. If a student elects to request evaluation of transfer credits, a transfer credit process 535 is initiated. If the request to grant transfer credits is approved, the transfer credits are reflected in the student record 555. If the request to grant transfer credits is not approved, the transfer credit process ends 545.

All prospective students who complete orientation are granted conditional admission to the virtual university 170 and notified of their status by an auto-generated e-mail. After the prospective students have submitted all necessary official admissions documents, their admission requirements and admission status are reviewed for “full acceptance.”

If a prospective student registers for a course, the prospective student is granted admission to the virtual university and enters the next stage 580. If the prospective student does not register for a course, a follow-up procedure is initiated 520.

Each time a student registers for a course he or she must elect some form of payment. Students may pay by credit card and have the option of deferring payment throughout the semester session using an automatic debit plan. Additionally, students may use education loans as payment. A student who is a member of the military may use military tuition assistance. In an embodiment, the virtual university may offer financial assistance in the form of scholarships. In an embodiment, scholarships may be offered. By way of illustration and not by way of limitation, an American Society of Industrial Security International scholarship is open to all current, active members of that society. A military spouse scholarship is open to the eligible spouses of active system students in the military. A university scholarship is awarded to eligible degree-seeking undergraduate students, but may not be combined with any other form of financial assistance.

Whatever the means of payment, a reminder is displayed on the student's student home page prior to the date when payment for a course or other charges due.

For many new students, another important aspect of the application stage is a transfer credit evaluation (TCE) process (FIG. 5, elements 530, 535, and 540). New students who have completed previous work at other institutions (referred to as “transfer students”) may be directed to apply for transfer credit during orientation. A request to transfer credits initiates a transfer credit evaluation process. Upon completion of the transfer credit evaluation process, the student is notified whether the transfer request has been granted.

In another embodiment, after a new student registers for a course and completes payment, books are automatically ordered and shipped to the student via a book ordering system. The virtual university 170 collates undergraduate course registrations and sends a booklist to one or more vendors for shipment to the students. In another embodiment, the virtual university provides links to an online book resource that stocks all the virtual university's courses materials. As previously indicated, the ordering functions may performed by a processor element, such as a processor element in a server (see FIG. 9) and/or a personal computer (see FIG. 10).

An acceptance stage FOM uses information captured during the acceptance stage to measure the acceptance stage performance. An orientation count register 560 captures the number of prospective students completing orientation (data point A). A registration count register 565 captures the number of prospective students registering for a class. A transfers-process register 570 captures the number of transfer credit requests processed over a period of time.

Other FOMs provide further information on courses and how students interacted with those courses. For example, the metrics estimate the number of courses dropped before the semester starts and the number dropped because the student did not submit military TA paperwork. Other metrics track the number of scholarships awarded and measure delivery time for undergraduate book shipments.

Conversion rates are determined and captured by a conversion rate register 575. By way of illustration and not by way of limitation, the conversion rates for the acceptance stage may include:
a number of applications received to the number of prospective students that progress to orientation;
a number of prospective students who initiate orientation and progress to registration; and
a number of applications to the number of prospective students that complete registration.

The FOM data thus collected can be used to produce reports related to desired objectives. As previously indicated, the creation and use of the FOMs may be performed by a processor element, such as a processor element in a server (see FIG. 9) and/or a personal computer (see FIG. 10).

In another embodiment, other data may be captured during the acceptance stage and additional conversion rates determined without departing from the scope. By way of illustrations and not as a limitation, data regarding courses dropped and the reasons why, the number of scholarships awarded, and the delivery time for undergraduate book shipments may be captured.

In still another embodiment, a student satisfaction quotient (SSQ) measures the effectiveness of the virtual university in providing for students from the student perspective. The SSQ is used by the virtual university in conjunction with student complaints and suggestions to develop corrective measures to strengthen the relationship between the virtual university and the student.

Referring back to the registration process, a student enters the first course stage when the student registers for his or her first online course and leaves the first course stage when the student registers for his or her last course.

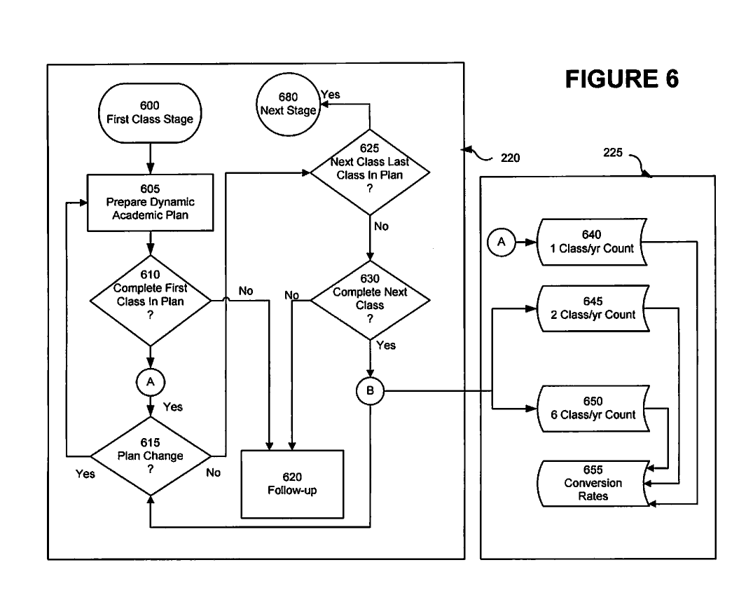

FIG. 6 illustrates a flow diagram of a first course stage according to an embodiment. A student who has completed registration for a first class enters a first course stage 600. The prospective student uses a student access device (see FIG. 1, 100) to create a dynamic academic plan 605 that establishes the student's academic goals and maps course offerings to allow that student to achieve those goals. The dynamic academic plan accounts for any transfer credits granted the student. If the student completes the first class in the dynamic academic plan 610, the student is given an opportunity to change the dynamic academic plan 615. If the student does not complete the first class in the dynamic academic plan, a follow-up process is initiated 620. If the student decides to change the dynamic academic plan, the student again prepares a dynamic academic plan 605. The revised dynamic academic plan accounts for transfer credits that may have been granted to the student, and if applicable, the first class taken by the student.

If the student chooses to proceed with the dynamic academic plan, a determination is made whether the next class in the dynamic academic plan is the last class in the dynamic academic plan 625. If the next class is the last class the student proceeds to the next stage 680. If the next class is not the last class in the dynamic academic plan, the student proceeds to the next class 630. If the student does not complete the next class, a follow-up process is initiated 620. If the student completes the next class, the student is given an opportunity to change the dynamic academic plan 615. This process continues until the student ceases to take classes or the next class is the last class.

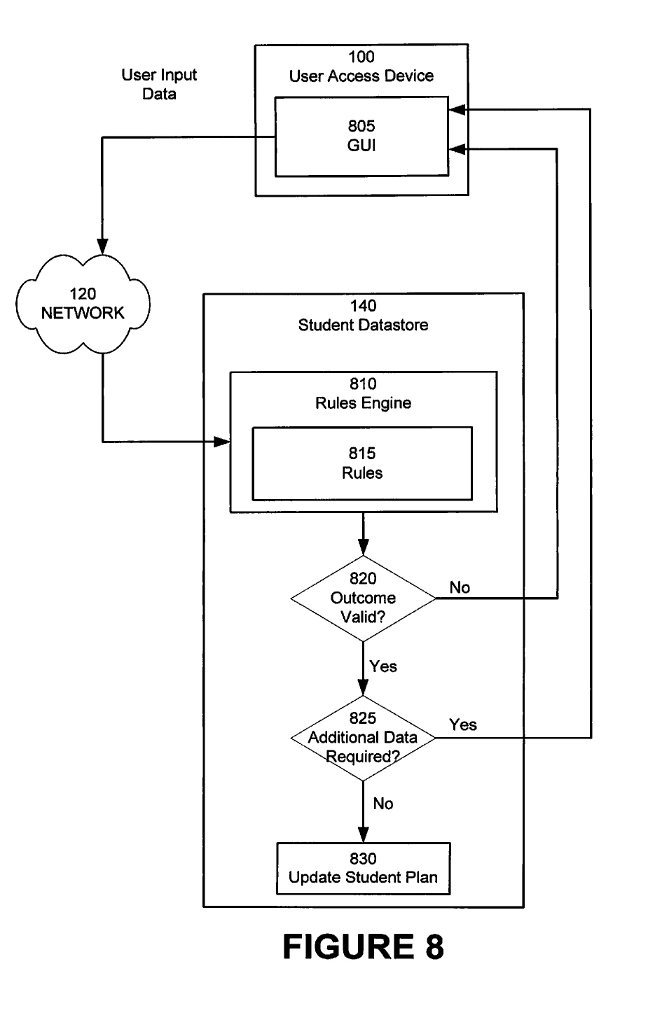

FIG. 8 is a block diagram illustrating a graphical user interface presented on a user access device and connected to a rules engine for dynamically creating and revising an academic plan according to an embodiment. In this embodiment, a student access device 100 interacts with a student datastore 140 via a graphical user interface (GUI) 805. As illustrated, the GUI 805 may be implemented on the student access device 100. Alternatively (but not illustrated), the GUI 805 may be operated on a server within the student datastore 140 and communicate with the student access device via a web browser (not illustrated) operating on the student access device 100.

The GUI 805 presents a user of the user access device 100 (sometime referred to herein as, the “student”) selection options. The student's selection of a selection option are conveyed by the GUI 805 to a rules engine 810. As illustrated, the rules engine 810 may reside in student datastore 140. However, this is not meant as a limitation. In other embodiments, the rules engine 810 may be accessible to the student datastore 140

The rules engine 810 applies rules 815 to the student's selection. A determination is made whether the outcome is valid (block 820). If the outcome of the rules engine 815 is not valid, that is, if the result of block 820 is “No,” the GUI 805 displays a message to the student indicating that the user input data produced an invalid result. By way of illustration and not by way of limitation, the message may inform the student of the reasons for the invalid result and provide guidance as to the content of a proper request.

If the outcome of the rules engine 815 is valid, a determination is made whether additional data is required 825. If additional data is not required, that is, if the result of block 825 is “No,” the outcome is used to update a student plan 830 stored in the student database 140. If additional data is needed, that is, if the result of block 825 is “Yes,” the GUI 805 displays a screen on the user access device 100 requesting the additional data. The additional data is then provided to the rules engine 815 as previously described and the process repeat until valid data is provided and the student database 140 is updated or until the student ceases to pursue the request.

In an embodiment, a student desires to register for a course. The student accesses the GUI 805 on the user access device 100 to select a course. The GUI 805 displays the student's personal degree plan. In an embodiment, sections of the degree plan in which required program hours have not been satisfied are presented with interactive links that provide access to a registration process. In an embodiment, sections of the degree plan in which required program hours have been satisfied are presented without interactive links thereby disabling course registration within this section. In yet another embodiment, sections of the degree plan that have been satisfied may be grayed out.

The student's selection is sent to the rules engine 810. By way of illustration and not by way of limitation, the rules engine 810 may apply the following rules:

[A] Determine if the course is open for registration.

[B] Determine if course max number of students has been reached.

[C] Determine if the student is a financial aid student, and, if so, determine if the course selection fits within the student's declared academic semester dates.

[D] Determine if the student has previously fulfilled course requirement with a course from the institution, a transfer credit, or a waiver.

[E] Determine if the student is on active academic status.

[F] Determine if the student is on financial hold.

[G] Determine if the student has the correct academic standing for selected course (undergraduate, senior, graduate).

[H] Determine if the student has fulfilled prerequisite course requirements.

[I] Determine if the student is registered for a course co-requisite.

[J] Determine if the student has reached semester course load maximum.

[K] Determine if the student has two or more incomplete grades.

[L] Determine if the student has passed a deadline for submitting admission documentation.

The rules engine 810 accesses student data stored in student datastore 140 and course data stored in university datastore 145 (see, FIG. 1) and applies rules to these data to evaluate a request. Referring to the rule set forth above, a request for registration will be processed when rules A, C, D, E, G, H and I are answered in the affirmative and rules B, F, J, K and L are answered in the negative. If the evaluation of any of the rules produces a different result, the request will be denied. The GUI 805 may present a message on user access device 100 indicating the specific rule that is blocking the student from registration.

In this embodiment, when the rules have been satisfied as indicated above, the GUI 805 presents a registration flow screen (not illustrated) on user access device 100. Some courses and/or course types may have additional rules. For example a rule for a particular class may require a student have a minimum number of completed class hours and a GPA meeting pre-established criteria.

Most online student campuses will now allow students to place a transcript order online. Usually these orders are reviewed by the Registrar's office, and first it is determined if the student is eligible to have a transcript released. Once this has been verified, the Registrar's office than releases the transcript order for processing.

In an embodiment, the rules engine 810 is further adapted to process transcript requests without requiring payment unless the order is accepted. A student accesses the GUI 805 on the user access device 100 to request a transcript. The student's request is sent to the rules engine 810.

By way of illustration and not by way of limitation, the rules engine 810 may apply the following rules:

[M] Determine if the student has completed a course at the institution (or a withdrawal from course).

[N] Determine if the student has turned in all documents required for full admission.

[O] Determine if the student is on financial hold.

Referring to the rule set forth above, a request for registration will be processed when rules M and N are answered in the affirmative and rule O is answered in the negative. If the evaluation of any of the rules produces a different result, the request will be denied. The GUI 805 may present a message on the user access device 100 indicating the specific rule that is blocking the student from obtaining a transcript. In this embodiment, when the rules have been satisfied as indicated above, the GUI 805 presents a transcript order screen (not illustrated) on user access device 100.

In an embodiment, a student desires to extend the time to complete a course. The student accesses the GUI 805 on the user access device 100 to select the course extension form. The student's selection of the form is sent to the rules engine 810. By way of illustration and not by way of limitation, the rules engine 810 may apply the following rules:

[P] Determine whether week two of the courses has already begun.

[Q] Determine whether the last week of the course has begun.

[R] Determine whether the student has dropped or withdrawn from the course.

[S] Determine whether the course has previously been extended up to the 60 day maximum.

Referring to the rule set forth above, the selection of the course extension form will be processed when rule P is answered in the affirmative and rules Q, R and S are answered in the negative. If the evaluation of any of the rules produces a different result, the request will be denied. The GUI 805 may present a message on user access device 100 indicating the specific rule that is blocking the student from selecting a course extension. In this embodiment, when the rules have been satisfied as indicated above, the GUI 805 presents the student the course extension form that is auto populated with the student's information, including all of the student's current courses, if any, that are still for extension.

In an embodiment, the student may select course that is eligible for extension from the list of extendible courses. The request may be routed to a faculty member for approval. The faculty member will receive an ‘alert’ in their workflow portal that an extension has been requested. If the faculty member opens the alert and clicks APPROVE, a workflow form is automatically removed from the faculty portal, the student is auto-emailed the approval notification, the student's student recorded is updated to reflect a grade of INCOMPLETE, and the course is extended by a predetermine period of time. The student may see the extended end date when the student accesses the course classroom and may receive warnings prior to the expiration of the extension. The faculty member may also be advised of this extension date may receive automatic notification when the extension ends and a final grade is due.

In another embodiment, the system uses rules engine 810 to review student records on a continuing basis. For example and without limitation, rules are applied to a student record to guide a student to the correct courses based on his or her current academic progress in a declared major. In this embodiment, the rules ensure that the student cannot inadvertently register in a course for which the program requirements are already fulfilled by a previous course or transfer credit, and cannot register in a course without meeting all entry requirements for that course. Similarly, if a student attempts to register for a course that is not required by the program in which the student is enrolled, the student is advised of this before registration is completed.

As previously indicated, the creation and revision of a dynamic academic plan may be performed by a processor element, such as a processor element in a server (see FIG. 9) and/or a personal computer (see FIG. 10).

A first course stage FOM uses information captured during the first course stage to measure stage performance. A one class per year count register 640 captures the number of prospective students completing a single class in a twelve-month period (a year). A two class per year count register 645 captures the number of prospective students completing two classes in a year. A six class per year count register 650 captures the number of prospective students completing six classes in a year. Other measures of classes completed over a period of time may also be established and the data captured accordingly.

Conversion rates are determined and captured by a conversion rate register 655. By way of illustration and not by way of limitation, a conversion rate for the first course stage may include:
a number of students completing one class in a year to the number of students taking classes;
a number of students completing two classes in a year to the number of students taking classes; and
a number of students completing six classes in a year to the number of students taking classes.

In an embodiment, other data may be captured during the first course stage and additional conversion rates determined. By way of illustrations and not as a limitation, data may be captured from the first class stage to determine a first course completion rate and the number and/or rate of students who passed, failed, dropped, or withdrew from a course. In another embodiment, an interactivity quotient in the classroom is determined by tracking how many students signed in on time for a class, the completion rate of homework assign assignments, and whether grades were posted in a timely manner. As previously indicated, the tracking functions described herein may be performed by a processor element, such as a processor element in a server (see FIG. 9) and/or a personal computer (see FIG. 10).

Throughout the “first class” stage, a student is monitored to ensure that he or she received any assistance needed to fulfill their academic goals and reach program completion. Degree-seeking students are tracked to ensure they meet their graduation deadline. The major role players vital to this process are faculty, staff, peers, alumni, and the website. The opportunities for all of these players to “touch” and assist a student are numerous. A student may receive help navigating through the learning process at any time.

In an embodiment, interactions between prospective students and the virtual university are monitored through the acceptance stage and interactions between students and the virtual university are monitored from the acceptance stage forward.

In an embodiment, a touch point comprises an event that triggers a response. The nature of a response is determined by the event that triggers it. By way of illustration, during the acceptance stage (see FIG. 4), if a prospective student leaves contact data, an acknowledgement response is generated. If it is detected that a student does not complete a class in an academic plan (see FIG. 6), an academic counseling response is triggered. If a student does not respond to an academic counseling response, a follow-up response is triggered. As will be apparent to those skilled in the art, other events may trigger additional responses. For example, and not as a limitation, a motivational response may be sent upon the successful completion of a class or upon reaching certain milestones toward completing an academic plan. An informational response may be sent to announce a new class offering, a new academic resource, or a change in a policy of the virtual university. In addition, a survey response may be sent to a student completing a set number of courses or achieving threshold tenure with the virtual university.

The dynamic academic plan is not only used by students to progress toward a stated academic goal, but provides the virtual university data needed to constantly monitor resource requirements on a prospective basis. In an embodiment, the dynamic academic plans of all students enrolled in a virtual university are compiled on a computing device to provide a time-based dynamic resource allocation plan. By way of illustration and not as a limitation, at a point in time, a dynamic resource allocation plan provides the classes that have been scheduled by the student body, and the classes that are projected to be scheduled at points in time in the future. Because a student may change his or her dynamic academic plan at any time, the dynamic resource allocation plan is also in flux, but is in sync with the prospective needs of the student body. As previously indicated, the creation and revision of a dynamic academic plan may be performed by a processor element, such as a processor element in a server (see FIG. 9) and/or a personal computer (see FIG. 10).

Through the use of software located in a classroom datastore (FIG. 1, 150) and using a student access device (FIG. 1, 100), students are able to participate in synchronous (i.e. A structured class held at a particular time) or asynchronous (i.e. self-learning) learning at any time, from any location. In an embodiment, the student access device may be any Internet-capable appliance including, for example, a PC, a PDA, or a cellular phone. Students may access their online classrooms prior to the start date of the class (provided that they have submitted payment for the course). Students may submit homework, take exams, and correspond with the faculty and other students while inside the classroom. In an embodiment, a student is not required to be online at a particular time of day. In another embodiment, a student must maintain weekly contact with their professor(s) by submitting assignments or sending e-mails from their online classroom mailbox. Classes close permanently after a grace period following the end date of the class, giving students on approved course extensions the time they need to complete all course assignments, and the professors the time they need to provide valuable feedback to the student and determine a final grade.

In an embodiment, students are provided access to a resources datastore (FIG. 1, 155). The resources datastore 155 is available to all students at all times and focuses on subject-specific Internet resource pages. It is also the starting point for access to online books, periodicals, and research web sites such as LexisNexis Academic, EBSCO's Academic Elite, and Loislaw, and for access to material provided by other educational institutions.

Throughout the first-class stage, students are monitored to ensure that they receive any assistance they need to fulfill their academic goals and reach program completion. Degree-seeking students are tracked to ensure they meet their graduation deadline. An important tool in tracking the students is the student database (FIG. 1, 140) that comprises a student record book that records each student's experience in the virtual university 170.

The first-class FOM illustrated in FIG. 5 are used to determine the partnership's effectiveness and the students' satisfaction. A constant measure of the students' progression toward their learning objective presents feedback and data on the strength of the partnership. Some FCAD measures include: first course completion rate; students who passed, failed, dropped, or withdrew from a course; students who took two courses and those who took four; etc. The FOM also measures the interactivity quotient in the classroom by tracking how many students signed in on time, how they progressed with their assignments, and whether the grades were posted in a timely manner. The FCAD FOM also includes a student survey at the end of each course used to analyze the reasons that students dropped, withdrew, or received incompletes.

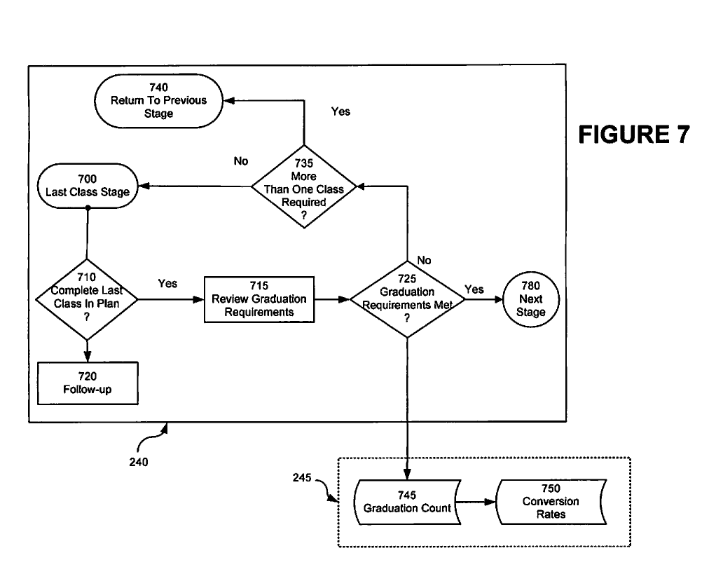

FIG. 7 illustrates a flow diagram of the “last-course” stage according to an embodiment. A student enters the last course stage when he or she registers for the last course required for degree or program completion. This registration is similar to the previously described registration process with the additional requirement that the student submits a graduation application form. Each graduating student is asked to complete a formal survey that is directed to the student's experience with the virtual university.

Referring to FIG. 7, a student who has registered for his or her last class enters the last class stage 700. If the student completes the last class in an academic plan 710, a review of the graduation requirements 715 is initiated. If the student does not complete the last class in an academic plan, a follow-up procedure is initiated 720. If the graduation requirements are not met, a determination is made as to whether more than one class is required for graduation 735. If only one class is required for graduation, the student re-enters the last class stage 700. If more than one class is required for graduation, the student re-enters the previous stage 740. As previously indicated, determinations related to graduation requirements may be performed by a processor element, such as a processor element in a server (see FIG. 9) and/or a personal computer (see FIG. 10).

A last course stage FOM uses information captured during the last course stage to measure stage performance. A graduation count register 745 captures the number of students fulfilling the requirements for graduation 745. Conversion rates are determined and captured by a conversion rate register 750. In an embodiment, a conversion rate is established to relate the following:
a number of students entering the virtual university to the number that graduate;
a number of students entering a particular degree program to the number of students in that degree program that graduate; and
a number of students who enter a degree program to the number that fail to complete the last class to qualify for the degree.

In an embodiment, other data may be captured during the last course stage and additional conversion rates determined. By way of illustrations and not as a limitation, the grades of graduates may be captured in a grade register and related to demographic data of those students. As previously indicated, the creation and use of the FOMs may be performed by a processor element, such as a processor element in a server (see FIG. 9) and/or a personal computer (see FIG. 10).

Another step in the system administration for students is the “last-course” stage 230, as illustrated in FIGS. 2 and 7. The last-course stage 230 begins when the student registers for the last course required for degree or program completion. This registration is much like all other registrations but there are additional steps that allow a student to receive a degree or certificate. Students completing a degree are allowed to apply for graduation six semester hours prior to completing their requirements for their degree and submit a graduation application form from their Student Record.

In another embodiment, the student datastore (FIG. 1, 140) may automatically produce a student Academic Plan according to rules for the declared major of the student, which plan tracks all program requirements. The Academic Plan may be updated as each course is completed or transfer credit is awarded. This automated function may be performed by a processor element, such as a processor element in a server (see FIG. 9) and/or a personal computer (see FIG. 10). Using the Academic Plan at each registration will enable the student to progress through the learning experience according to rules that define the expected or required courses and electives that are appropriate for the declared major of the student.

In an embodiment, a rules engine may be used to conduct a graduation audit. In this embodiment, rules are applied to a student record to determine whether all requirements for completion of a program have been satisfied.

Upon completion of a program earning a degree, students may choose to graduate at a distance, in person, or both ways. Those who wish to graduate at a distance may arrange for their own ceremony after being sent their final transcripts and notified of when to expect their diploma.

Each graduating student may be asked to complete a formal survey that covers the entire experience with the system and its various embodiments and his or her individual learning experience. Students may be counseled on their continued education, offered career counseling and extended the opportunity to become a mentor to a current system student.

The last-class FOM illustrated in FIG. 7 may be used to measure the effectiveness of the partnership and include the formal survey results and grade analysis of the graduates.

The fifth and sixth step of the partnership at a distance is GRAD (Graduation At a Distance) 240 and ALAD (Alumni At a Distance) 255, as illustrated in FIG. 2. A student enters the graduation stage upon completion of the last course necessary for a degree. A student can elect to attend a commencement ceremony, plan to have their diploma presented by an official of their own choice at their own location, or opt to have no ceremony at all. A graduation FOM 245 is used to calculate the effectiveness of the virtual university via graduation rates, which are measured by cohort, degree and program of study.

The GRAD FOM are used to calculate the effectiveness of the partnerships via graduation rates, which are measured by cohort, degree and program of study.

FIG. 2 also illustrates an alumni stage 250. A student enters the alumni stage upon degree completion. After their degree completion, alumni are sent a survey that focuses on their learning outcomes and the applicability of their academic experience to their work place. The alumni are also asked to provide the names of their current managers who are surveyed to determine the effectiveness of the alumni's course of study on his or her performance. The virtual university's alumni are then surveyed every two-years and the information is studied as a part of the virtual university's improvement process.

The alumni stage FOMs 255 are used to determine the effectiveness of alumni mentoring via the numbers of alumni actively involved in alumni programs and the numbers of alumni mentors.

There are many opportunities for the web, staff, and faculty to communicate with, or “touch”, various students throughout their partnership at a distance. In the PAD concept these opportunities are called Touch Points and they are categorized as follows: Academic Counseling, Acknowledgement, Follow-Up, Informational, Motivational, and Survey.

Throughout the system administration as illustrate, a series of automated “touch points” is established to facilitate the presented learning experience of a degree-seeking undergraduate. Many of the Touch Point messages are sent out depending on the student's specific requirements or needs. Students who reach their academic goal and progress from applicant to alumnus with no need for special contact with staff or faculty will receive automatically a number of e-mailed Touch Points during their academic experience. Such touch point may be, for example, acknowledgements of enrollment, informational messages and the like. For those students having academic difficulty, the system will provide such touch points as counseling, encouragement, motivational and follow-up messages. These touch point messages are automatically generated based upon a continuing rule based analysis of each student's academic progress. Thus messages are sent out on a continuing basis to those students for whom a rule based analysis determines that such touch point messages are required or desirable.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Further, words such as “thereafter,” “then,” “next,” etc. are not intended to limit the order of the steps; these words are simply used to guide the reader through the description of the methods.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of the computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module which may reside on a computer-readable medium. Computer-readable media include both computer storage media and communication media including any medium that facilitates transfer of a computer program from one place to another. Storage media may be any available media that may be accessed by a computer. By way of example, and not limitation, such computer-readable media may comprise RAM, ROM, EEPROM, CD-ROM or other optical disc storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of media. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein but is to be accorded the widest scope consistent with the principles and novel features disclosed herein. Further, any reference to claim elements in the singular, for example, using the articles “a,” “an,” or “the,” is not to be construed as limiting the element to the singular.

What is claimed is:

1. A method for managing a student academic plan at an academic institution comprising:
a rules engine receiving a request to manage an academic plan of a student from a user access device;
the rules engine accessing data stored in a first memory, wherein the data are indicative of the standing of the student with the academic institution at a point in time and are selected based on the request;
selecting rules stored in a second memory based on the request;
the rules engine applying the selected rules to the selected data to determine whether to grant the request; and
updating the data stored in the first memory when the request is granted.

2. The method of claim 1, wherein the academic institution is a virtual university.

3. The method of claim 1, wherein the user access device is selected from the group consisting of a laptop computer, a desk top computer, a mini-computer, a personal data assistant and a smart phone.

4. The method of claim 1,
wherein the request to manage an academic plan comprises a request to register for a course,
wherein the data are indicative of a selected program and courses successfully completed by the student, and
wherein the rules engine applying the selected rules to the selected data to determine whether to grant the request comprises using the rules engine to apply the selected rules to the selected data to determine whether the requested course is a required by the student to fulfill the requirements of the selected program.

5. The method of claim 4, wherein the rules engine applying the selected rules to the selected data to determine whether the requested course is required by the student to fulfill the requirements of the selected program comprises making at least one determination selected from the group consisting of the requested course is not a course that is required for the selected program, the student has successfully completed the requested course, the student has received a transfer credit obviating the need to take the requested course, and the student has received a waiver obviating the need to take the requested course.

6. The method of claim 1 further comprising sending a message to the user access device when the request is denied, wherein the message comprises a reason for denying the request.

7. A method for managing for managing a student academic plan at an academic institution comprising:
requesting access to a student academic plan from a user access device for a student;
a rules engine receiving the request for access to the academic plan of the student;
the rules engine accessing data stored in a first memory, wherein the data are indicative of the standing of the student with the academic institution at a point in time and are selected based on the request;
selecting rules stored in a second memory based on the request;
the rules engine applying the selected rules to the selected data to generate the academic plan at the point in time;
providing the academic plan to the user access device; and
displaying the academic plan on the user access device via a graphical user interface.

8. The method of claim 7, wherein the academic institution is a virtual university.

9. The method of claim 7, wherein the user access device is selected from the group consisting of a laptop computer, a desk top computer, a mini-computer, a personal data assistant and a smart phone.

10. The method of claim 7,
wherein the rules engine applying the selected rules to the selected data to generate the academic plan at the point in time comprises using the rules engine to apply the selected rules to the selected data to:
determine courses required to complete the selected program,
identify courses required to complete the selected program that have been satisfied by the student, and
identify course required to complete the selected program remaining to be satisfied by the student, and
wherein, displaying the academic plan on the user access device via a graphical user interface comprises displaying the courses remaining to be satisfied with links to a registration process and displaying the courses that have been satisfied without links to the registration process.

11. A system for managing a student academic plan at an academic institution comprising:
a network;
a user access device having access to the network, wherein the user access device comprises a first processor configured with software executable instructions that cause the first processor to perform operations comprising generating a request to manage a student academic plan in response to a user request;
a first memory accessible to the network, wherein the first memory comprises data indicative of the standing of the student with the academic institution at a point in time;
a rules engine connected to the network, wherein the rules engine comprises a second processor configured with software executable instructions that cause the rules engine to perform operations comprising:
receiving the request from the user access device;
selecting data stored in the first memory based on the request;
selecting rules stored in a second memory based on the request;
applying the selected rules to the selected data to determine whether to grant the request; and
updating the data stored in the first memory when the request is granted.

12. The system of claim 11, wherein the academic institution is a virtual university.

13. The system of claim 11, wherein the user access device is selected from the group consisting of a laptop computer, a desk top computer, a mini-computer, a personal data assistant and a smart phone.

14. The system of claim 11,
wherein the request to manage an academic plan comprises a request to register for a course,
wherein the data are indicative of a selected program and courses successfully completed by the student, and
wherein the operation of applying the selected rules to the selected data to determine whether to grant the request comprises an operation for applying the selected rules to the selected data to determine whether the requested course is a required by the student to fulfill the requirements of the selected program.

15. The system of claim 14, wherein the operation for applying the selected rules to the selected data to determine whether the requested course is required by the student to fulfill the requirements of the selected program comprises an operation for making at least one determination selected from the group consisting of the requested course is not a course that is required for the selected program, the student has successfully completed the requested course, the student has received a transfer credit obviating the need to take the requested course, and the student has received a waiver obviating the need to take the requested course.

16. The system of claim 11, wherein the second processor is further configured with a software instruction that causes the rules engine to perform an operation of sending a message to the user access device when the request is denied, wherein the message comprises a reason for denying the request.

17. A system for managing for managing a student academic plan at an academic institution comprising:
a network;
a user access device having access to the network, wherein the user access device comprises a first processor configured with software executable instructions that cause the first processor to perform operations comprising generating a request to access a student academic plan in response to a user request;
a first memory accessible to the network, wherein the first memory comprises data indicative of the standing of the student with the academic institution at a point in time;
a rules engine connected to the network, wherein the rules engine comprises a second processor configured with software executable instructions that cause the rules engine to perform operations comprising:
receiving the request for access to the academic plan from the user access device;
selecting data stored in the first memory based on the request;
selecting rules stored in a second memory based on the request;
providing the academic plan to the user access device; and
displaying the academic plan on the user access device via a graphical user interface.

18. The system of claim 17, wherein the academic institution is a virtual university.

19. The system of claim 17, wherein the user access device is selected from the group consisting of a laptop computer, a desk top computer, a mini-computer, a personal data assistant and a smart phone.

20. The system of claim 17,
wherein the operation for applying the selected rules to the selected data to generate the academic plan at the point in time comprises:
determining courses required to complete the selected program,
identifying courses required to complete the selected program that have been satisfied by the student, and
identifying course required to complete the selected program remaining to be satisfied by the student, and
wherein, the operation for displaying the academic plan on the user access device via a graphical user interface comprises displaying the courses remaining to be satisfied with links to a registration process and displaying the courses that have been satisfied without links to the registration process.

21. A method for optimizing the effectiveness of a university environment comprising:
receiving at a server a request for an academic plan from a member of a student body from a student access device, wherein the student body comprises a plurality of students;
using the server to prepare a dynamic academic plan for the member of the student body according to a first set of rules; and
using the server to map one or more course offerings to the member of the student body based on the academic plan of that member according to a second set of rules.

22. The method of claim 21 further comprising:
determining if the dynamic academic plan of one member of the student body has been changed; and
mapping one or more course offerings for that member based on the changed academic plan.
